(19) United States
(12) Patent Application Publication
(10) Pub. No.: US 2024/0361619 A1
(43) Pub. Date: Oct. 31, 2024

(54) CAPACITIVE TOUCH MIRROR INTERFACE

(71) Applicant: Gentex Corporation, Zeeland, MI (US)

(72) Inventors: Eric S. Lundy, Holland, MI (US); Michael J. Taylor, Dorr, MI (US); Andrew D. Weller, Holland, MI (US); Xiaoxu Niu, Grand Rapids, MI (US); Nigel T. Lock, Holland, MI (US)

(73) Assignee: Gentex Corporation, Zeeland, MI (US)

(21) Appl. No.: 18/645,861

(22) Filed: Apr. 25, 2024

Related U.S. Application Data
(60) Provisional application No. 63/498,901, filed on Apr. 28, 2023.

(51) Int. Cl. G02F 1/01; B60R 1/08; B60R 1/12

(52) U.S. Cl. CPC G02F 1/0102; B60R 1/088; B60R 1/12; B60R 2001/1223

(57) ABSTRACT

An electro-optic assembly includes a first substrate that has a first surface and a second surface opposite the first surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode. A concealment layer is located between the electro-optic medium and the first surface and a user interface defines a touch input sensor aligned with the concealment layer.

### CROSS-REFERENCE TO RELATED APPLICATION

This application claims priority to and the benefit under 35 U.S.C. § 119(e) of U.S. Provisional Application No. 63/498,901, filed on Apr. 28, 2023, entitled “CAPACITIVE TOUCH MIRROR INTERFACE,” the disclosure of which is hereby incorporated herein by reference in its entirety.

### FIELD OF THE DISCLOSURE

The present disclosure generally relates to a mirror assembly, and, more particularly, to a mirror assembly that includes a touch interface.

### SUMMARY OF THE DISCLOSURE

According to one aspect of the present disclosure, an electro-optic assembly includes a first substrate that has a first surface and a second surface opposite the first surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode. A concealment layer is located between the electro-optic medium and the first surface, and a user interface defines a touch input sensor aligned with the concealment layer.

According to another aspect of the present disclosure, an electro-optic assembly includes a first substrate that has a first surface and a second surface opposite the first surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode. A concealment layer is located between the electro-optic medium and the first surface, and touch input sensor defining a plurality of touch input sections is aligned with the concealment layer.

According to yet another aspect of the present disclosure, an electro-optic assembly includes a first substrate that has a first surface and a second surface opposite the first surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode. A front substrate has a front surface and a rear surface, the rear surface and the first surface facing each other. A concealment layer is located between the electro-optic medium and the front surface, and a user interface defines a touch input sensor aligned with the concealment layer.

According to yet another aspect of the present disclosure, an electro-optic assembly includes a first substrate that has a first surface and a second surface opposite the first surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode. A front substrate has a front surface and a rear surface, the rear surface and the first surface facing each other. A concealment layer is located between the electro-optic medium and the front surface, and a user interface defines a touch input sensor aligned with the concealment layer.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a cross-sectional view of an electro-optic assembly of a first construction in accordance with the present disclosure;

FIG. 2A is a top plan view of a vehicle incorporating an electro-optic assembly in accordance with the present disclosure;

FIG. 2B is a top perspective view of an aircraft incorporating an electro-optic assembly in accordance with the present disclosure;

FIG. 2C is a front elevational view of a building incorporating an electro-optic assembly in accordance with the present disclosure;

FIG. 2D is a top perspective view of an eyewear assembly incorporating an electro-optic assembly in accordance with the present disclosure;

FIG. 3 is a cross-sectional view of an electro-optic assembly of a second construction in accordance with the present disclosure;

FIG. 4 is a full display review mirror assembly building incorporating an electro-optic assembly in accordance with the present disclosure; and

FIG. 5 is a schematic view of a control system that controls functionalities of an electro-optic assembly in accordance with an aspect of the present disclosure.

### DETAILED DESCRIPTION

The present illustrated embodiments reside primarily in combinations of method steps and apparatus components related to a mirror assembly that includes a touch interface. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

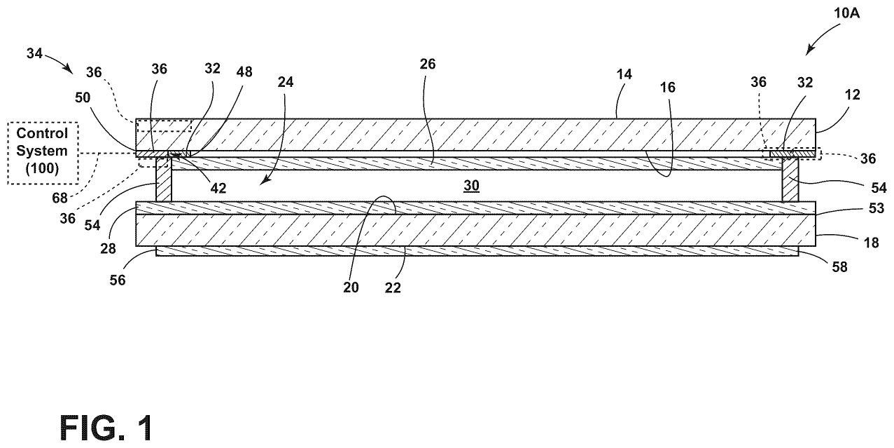

For purposes of description herein, the terms “upper,” “lower,” “right,” “left,” “rear,” “front,” “vertical,” “horizontal,” and derivatives thereof, shall relate to the disclosure as oriented in FIG. 1. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

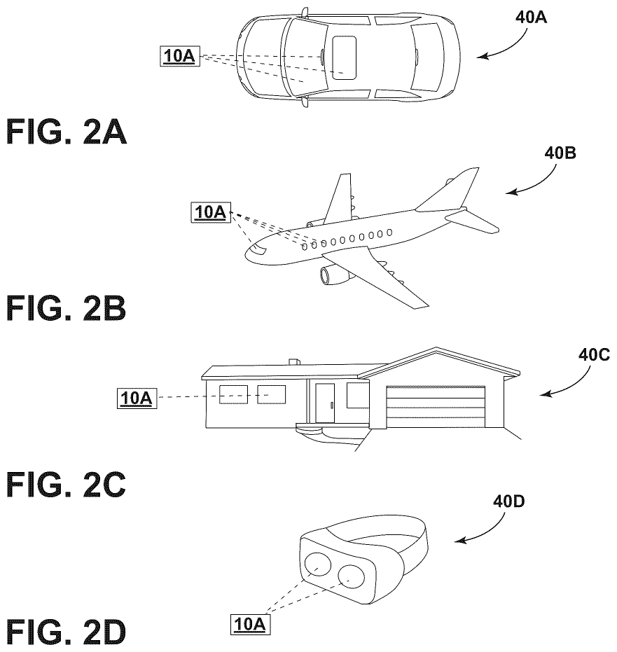

Referring to FIGS. 1-2D, reference numeral 10A generally designates an electro-optic assembly of a first construction. The electro-optic assembly 10A includes a first substrate 12 that has a first surface 14 and a second surface 16 opposite the first surface 14. A second substrate 18 has a third surface 20 and a fourth surface 22 opposite the third surface 20. The second and third surfaces 16, 20 face each other to define a gap 24. A first electrode 26 is coupled (e.g., directly connected and layered over) to the second surface 16 and a second electrode 28 (e.g., directly connected and layered over) is coupled to the third surface 20. An electro-optic medium 30 is located between the first electrode 26 and the second electrode 28. A concealment layer 32 is located between the electro-optic medium 30 and the first surface 14, and a user interface 34 defines a touch input sensor 36 aligned with the concealment layer 32.

With reference now to FIGS. 2A-2D, the electro-optic assembly 10A may be incorporated with one or more structures 40A-40C. For example, FIG. 2A illustrates an automobile 40A employing the electro-optic assembly 10A, for example, with an interior rearview mirror, a sunroof, a windshield, a side window, a heads-up display, and/or other interior vehicle locations that display one or more aspects of the electro-optic assembly 10A. The automobile 40A may include a commercial vehicle, an emergency vehicle, a residential vehicle, or the like. FIG. 2B illustrates an aircraft 40B employing the electro-optic assembly 10A (e.g., a front window, side window, heads-up display). FIG. 2C illustrates a building 40C employing electro-optic assembly 10A (e.g., a window). The building 40C may be a residential building, a commercial building, and/or the like. Generally speaking, the electro-optic assembly 10A may be incorporated into any environment where it is beneficial to change the state of a window, mirror, and/or display. FIG. 2D illustrates eyewear 40D employing electro-optic assembly 10A. For example, the eyewear 40D may include glasses with dimming functionality, augmented reality, or semi-augmented reality. Generally speaking, other structures, may incorporate the electro-optic assembly 10A where switching between transmission and/or reflective states may be beneficial.

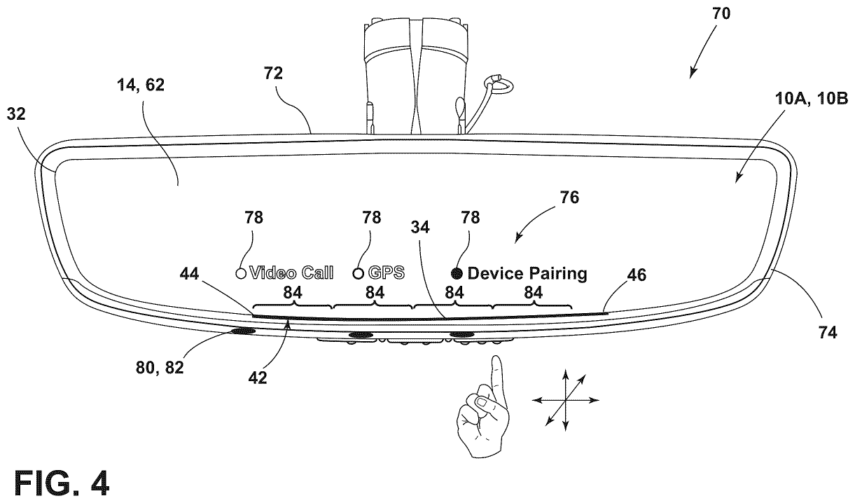

With reference now to FIG. 1, the touch input sensor 36 extends in alignment with the concealment layer 32. The terms “aligned” or “in alignment” should be understood to be overlapping (e.g., fully or partially) an exterior boundary of the concealment layer 32 from a viewer's perspective. Further aligned should be understood to be co-planar, in a forward direction (i.e., a direction from the fourth surface 22 towards the first surface 14), or in a rearward direction (i.e., a direction from the first surface 14 towards the fourth surface 22). For example, the concealment layer 32 may define an opening 42 and the touch input sensor 36 may aligned with the opening 42. More particularly, the touch input sensor 36 may be at least partially within the opening 42, between the opening 42 and the fourth surface 22, and/or between the opening 42 and the first surface 14. The opening 42 may be elongated between a first end 44 and a second end 46, and the touch input sensor 36 extends between the first end 44 and the second end 46 (FIG. 4). The opening 42 may be formed by ablating the concealment layer 32. The concealment layer 32 may include an inner perimeter 48 and an outer perimeter 50. In some embodiments, the opening 42 may be formed between the inner perimeter 48 and the outer perimeter 50. In some embodiments, the opening 42 extends entirely through the concealment layer 32 (e.g., from the inner perimeter 48 to the outer perimeter 50). In other embodiments, the opening 42 may be partially defined by the inner or outer perimeters 48, 50 (e.g., a bay or notch).

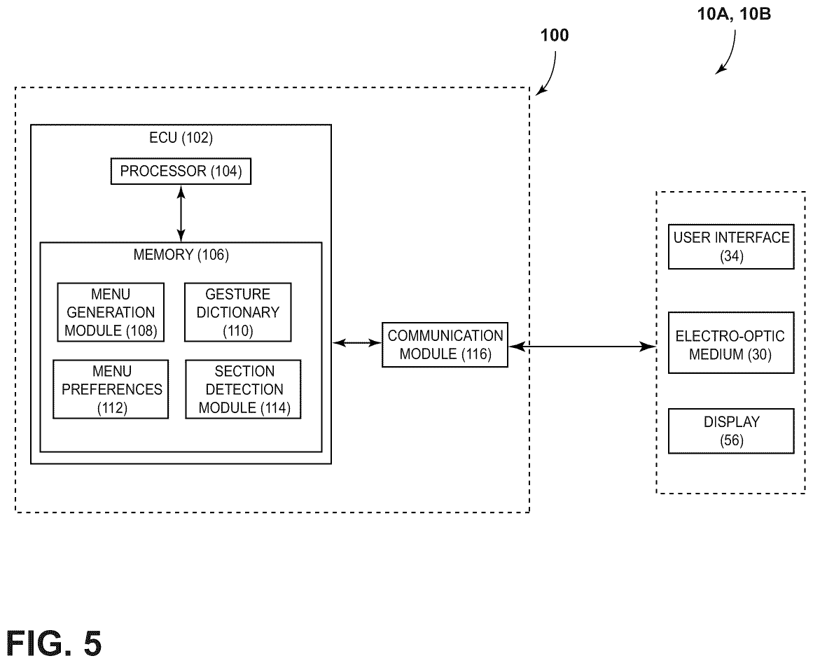

The touch input sensor 36 is touch-activated. For example, the touch input sensor 36 may be configured as a conductive layer that stores an electrical charge that reduces from an operator's touch. The reduction in the electrical charge of the conductive layer can be detected by a control system 100 (FIG. 5). The touch input sensor 36 (e.g., the conductive layer) may be formed of one or more transparent, opaque, or reflective materials. For example, the touch input sensor 36 (e.g., the conductive layer) may be formed of zinc oxide, indium tin oxide (ITO), fluorine doped tin oxide, indium zinc oxide, conductive polymers, thin metal films, metal grid/mesh, metal networks, carbon nanotubes, nanowires, or chrome. However, it should be appreciated that the touch input sensor 36 may be configured to respond to other detected changes, such as resistive changes, scattered light changes, surface acoustic changes, and/or the like. In some embodiments, the touch input sensor 36 may be at least partially planar with the concealment layer 32. In other words, the touch input sensor 36 may be both aligned and at least partially located within the opening 42, integral with concealment layer 32, or planar with the concealment layer 32 and within a boundary of the concealment layer 32.

With continued reference to FIG. 1, a seal 54 may be located within the gap 24 in order to contain the electro-optic medium 30 in an inboard direction. The concealment layer 32 may overlap and cover the seal 54 from a direction of the first surface 14. More particularly, the seal 54 may be aligned between the inner and outer perimeters 48, 50 such that it is not visible to a user viewing the electro-optic assembly 10A. The concealment layer 32 may be reflective (e.g., a metal ring formed a combination of chrome and additional metal layers), opaque (e.g., a glass frit), or another material (e.g., ink, metal, etc.) that is either reflective or opaque to conceal components in an element outer periphery 53 of electro-optic assembly 10A, such as the seal 54. In some embodiments, the concealment layer 32 is located on the first surface 14 or the second surface 16 of the first substrate 12.

The electro-optic assembly 10A may include a display 56 (e.g., LCD, OLED, LED) located proximate second substrate 18 on a side of the fourth surface 22. The display 56 may include a display perimeter 58 that is located within the element outer periphery 53 of electro-optic assembly 10A. In some embodiments, the concealment layer 32 may be configured to conceal the display perimeter 58 and the seal 54 may be hidden by a portion of the structures 40A-40C. In some embodiments, the touch input sensor 36 (e.g., the conductive layer) may be formed of the same material and coextensive (e.g., integral) with the concealment layer 32. For example, both the conductive layer and the concealment layer 32 may be formed of chrome and/or other metals. It should be appreciated that, in some embodiments, the electro-optic medium 30 may include a solution-phase, liquid or gel-based medium requiring the seal 54. However, in other embodiments, electro-optic medium 30 may include a film-based medium, thus not requiring the seal 54. In some embodiments, the touch input sensor 36 (e.g., the conductive layer) may be sandwiched between the second surface 16 and the seal 54. In some embodiments, the seal 54 spaces the touch input sensor 36 (e.g., the conductive layer) from the electro-optic medium 30 to prevent electrical interference between components. The spacing between the touch input sensor 36 and the electro-optic medium 30 as defined by the seal 54 may be 0.1 mm or more, for example, 0.5 mm or more, 0.8 mm or more, 0.9 mm or more, or about 1 mm. Other possible locations of the touch input sensor 36 are illustrated in dashed lines and may include a location at least partially within the seal 54 or a location at least partially imbedded within one of the substrates 12, 18.

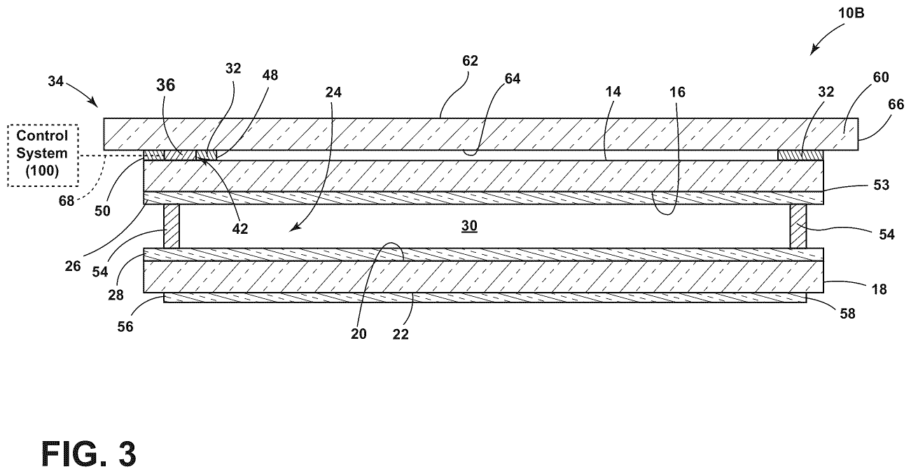

With reference now to FIG. 3, an electro-optic assembly 10B is illustrated in accordance with a second construction. Unless otherwise specified, the first and second constructions may share all the same features, materials, components, and functionalities. However, the electro-optic assembly 10B includes a front substrate 60 that defines a front surface 62 (e.g., a viewing surface) and a rear surface 64 directed towards the first substrate 12. In some embodiments, the concealment layer 32 is located between the first surface 14 of the first substrate 12 and the rear surface 64 of the front substrate 60. In other embodiments, the concealment layer 32 may be located on the front surface 62 of the front substrate 60. In some embodiments, the front substrate 60 defines a viewing perimeter 66 and the element outer periphery 53 is substantially within the viewing perimeter 66. In such embodiments, the concealment layer 32 may be sized and shaped to conceal the element outer periphery 53. It should be appreciated, however, that the concealment layer 32 may include two or more layers, branches, and shapes for concealing the components of the electro-optic assembly 10B.

With reference now to FIGS. 1 and 3, the touch input sensor 36 of the electro-optic assembly 10A, 10B may be electrically coupled to the control system 100 via one or more electrical contacts 68. For example, the electrical contacts 68 may be formed of conductive structures, such as one or more conductive clips, other metal structures, a conductive coating, a conductive ink, a solder, wires, a conductive epoxy, a conductive paste, a conductive adhesive, a conductive tape, buses, conductive springs, the like, and/or combinations thereof.

With reference now to FIG. 4, the electro-optic assembly 10A, 10B may be incorporated into a variety of structures 40A-40D. In some embodiments, the structures 40A-40D may include a mirror assembly 70 (e.g., FIG. 2A). The rearview mirror assembly 70 may include a housing 72 and a bezel 74 that, together, at least partially surround the electro-optic assembly 10A, 10B. The control system 100 may be located within the housing 72, for example, on one or more printed circuit boards (“PCBs”) within the housing 72. As will be described in greater detail below, the control system 100 may control various features of the electro-optic assembly 10A, 10B, such as electro-activating the electro-optic medium 30, generating graphics on the display 56, and receiving detected inputs on the touch input sensor 36. The touch input sensor 36 may be located along a bottom edge of the electro-optic assembly 10A, 10B.

With continued reference to FIG. 4, the control system 100 may be configured to detect an input on the touch input sensor 36 (e.g., a change in capacitance) and generate a menu 76 with a plurality of options 78 (e.g., two or more) that are each aligned with different sections of the touch input sensor 36. An indicia 80 may provide a visual notification to an operator where the touch input sensor 36 is located. The indicia 80 may include patterns in the concealment layer 32, textures on the bezel 74, graphics on the display 56, or illumination from light sources 82 aligned with the touch input sensor 36. The touch input sensor 36 may include several sections 84 or segments that are coextensive or spaced from one another. Each section 84 may be aligned with a different one of the indicia 80 and/or the light sources 82. In addition, each section 84 may correspond to a different response from the user interface 34. In some embodiments, the control system 100 is configured to generate each of the options 78 in alignment with a different one of the sections 84. In addition to touch, the control system 100 may also be configured to recognize different types of gestures on the touch input sensor 36, such as swiping, holding, scrolling, or tapping. In some embodiments, the light sources 82 may be at least partially imbedded and/or otherwise located on the bezel 74. In other embodiments, the light sources 82 may be located within the electro-optic assembly 10A, 10B (e.g., behind the fourth surface 22). In some embodiments, the mirror assembly 70 is a full display rearview mirror assembly that includes the electro-optic assembly 10A, 10B with the display 56. The full display rearview mirror assembly may be configured to generate images from one or more cameras (not shown) within or exterior to an associated vehicle. In some embodiments, the camera may be located in the housing 72. In other embodiments, the mirror assembly 70 is a more traditional rearview mirror assembly that includes the electro-optic assembly 10A, 10B without the display 56. In such instances, the control system 100 may be configured to provide feedback through means other than the display 56 (e.g., the light sources 82).

With reference now to FIG. 5, the control system 100 of the electro-optic assembly 10A, 10B may include at least one electronic control unit (ECU) 102. The at least one ECU 102 may be located in the housing 72 and/or other structures 40A-40D. The at least one ECU 102 may include the processor 104 and a memory 106. The processor 104 may include any suitable processor 104. Additionally, or alternatively, the ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid state) memory, or the like. The memory 106 may include Random Access Memory (RAM), a Read-Only Memory (ROM), Electrically Erasable Programmable Read-Only Memory (EEPROM), or a combination thereof. The memory 106 may include instructions that, when executed by the processor 104, cause the processor 104 to, at least, perform the functions associated with the components of the electro-optic assembly 10A, 10B, such as the user interface 34. Electro-activating the electro-optic medium 30, generating graphics on the display 56, and receiving detected inputs on the touch input sensor 36, may, therefore, be controlled by the control system 100. In addition, other functionalities related to the structures 40A-40D may be controlled by the control system 100, such as overhead lights, garage doors, entertainment systems, security systems, video calls, and/or the like. The memory 106 may include modules (e.g., instructions) that include a menu generation module 108, a gesture dictionary 110, and a personalized menu preferences 112. The control system 100 may further include one or more section detection modules 114 for correlating inputs to different ones of the sections 84 (e.g., changes of capacitance and the location of the changes) on the touch input sensor 36 by the operator. The control system 100 may further include a communication module 116 that transmits the instruction to generate the menu 76 in the user interface 34 and/or communicates with the one or more structures 40A-40D, control systems thereof, and/or mobile devices.

With reference now to FIGS. 1-5, the inputs received by the touch input sensor 36 may correspond to operations of the electro-optic device 10A, 10B. For example, the inputs received by the touch input sensor 36 may effectuate energizing and/or de-energizing the electro-optic medium 30, utilizing the display 56 (e.g., generating graphics, displaying images from the one or more cameras, a global position system, etc.), communication networks (e.g., pairing mobile devices, making and receiving calls and video calls, opening a closing a garage door, etc.) or controlling features of the one or more structures 40A-40D, independently or via communication with other control systems. For example, the inputs received by the touch input sensor 36 may control features of the structure 40A-40D, such as controlling lights, audio, temperature settings, opening and closing a window, the like, and/or combinations thereof.

The disclosure herein is further summarized in the following paragraphs and is further characterized by combinations of any and all of the various aspects described therein.

According to one aspect of the present disclosure, an electro-optic assembly includes a first substrate that has a first surface and a second surface opposite the first surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode. A concealment layer is located between the electro-optic medium and the first surface, and a user interface defines a touch input sensor aligned with the concealment layer.

According to another aspect, a concealment layer defines an opening and a touch input sensor is aligned with the opening.

According to yet another aspect, an opening is elongated between a first end and a second end and a touch input sensor extends between the first end and the second end.

According to still yet another aspect, a touch input sensor includes a conductive layer that stores an electrical charge.

According to another aspect, a seal is located within a gap and contains an electro-optic medium in an inboard direction.

According to yet another aspect, a concealment layer overlaps and covers a seal from a direction of a front surface.

According to still yet another aspect, a concealment layer includes a metal ring at least partially formed of chrome.

According to another aspect, a display is located behind a second substrate that is opposite a first substrate.

According to yet another aspect, a control system is configured to detect an input on a touch input sensor and generate a menu with two or more options that are each aligned with different sections of the touch input sensor.

According to yet another aspect, an input includes at least one of tap inputs and swipe inputs.

According to still yet another aspect, a light source aligned with a touch input sensor.

According to another aspect, a rearview mirror for a vehicle includes an electro-optic assembly.

According to another aspect of the present disclosure, an electro-optic assembly includes a first substrate that has a first surface and a second surface opposite the first surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode. A concealment layer is located between the electro-optic medium and the first surface, and touch input sensor defining a plurality of touch input sections is aligned with the concealment layer.

According to another aspect, an electro-optic assembly includes a plurality of indicia, each one of the plurality of indicia aligned with a different one of a touch input section.

According to yet another aspect, a concealment layer defines an opening and a touch input sensor is aligned with the opening.

According to still another aspect, a concealment layer defines an opening and a touch input sensor is located between the opening and an electro-optic medium.

According to another aspect, a touch input sensor is located within the concealment layer. According to yet another aspect of the present disclosure, an electro-optic assembly includes a first substrate that has a first surface and a second surface opposite the first surface. A second substrate has a third surface and a fourth surface opposite the third surface. The second and third surfaces face each other to define a gap. A first electrode is coupled to the second surface and a second electrode is coupled to the third surface. An electro-optic medium is located between the first electrode and the second electrode. A front substrate has a front surface and a rear surface, the rear surface and the first surface facing each other. A concealment layer is located between the electro-optic medium and the front surface, and a user interface defines a touch input sensor aligned with the concealment layer.

According to another aspect, a rearview mirror for a vehicle includes an electro-optic assembly.

According to yet another aspect, a touch input sensor is located between a first surface and a front surface.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. An electro-optic assembly comprising:
a first substrate having a first surface and a second surface opposite the first surface;
a second substrate having a third surface and a fourth surface opposite the third surface, the second and third surfaces facing each other to define a gap;
a first electrode coupled to the second surface;
a second electrode coupled to the third surface;
an electro-optic medium located between the first electrode and the second electrode;
a concealment layer located between the electro-optic medium and the first surface; and
a user interface defining a touch input sensor aligned with the concealment layer.

2. The electro-optic assembly of claim 1, wherein the concealment layer defines an opening and the touch input sensor is aligned with the opening.

3. The electro-optic assembly of claim 2, wherein the opening is elongated between a first end and a second end and the touch input sensor extends between the first end and the second ends.

4. The electro-optic assembly of claim 1, wherein the touch input sensor includes a conductive layer that stores an electrical charge.

5. The electro-optic assembly of claim 1, further including a seal located within the gap and containing the electro-optic medium in an inboard direction.

6. The electro-optic assembly of claim 5, wherein the concealment layer overlaps and covers the seal from a direction of the first surface.

7. The electro-optic assembly of claim 1, wherein the concealment layer includes a metal ring at least partially formed of chrome.

8. The electro-optic assembly of claim 1, further including a display located behind the second substrate and opposite the first substrate.

9. The electro-optic assembly of claim 8, further including a control system configured to detect an input on the touch input sensor and generate a menu with two or more options that are each aligned with different sections of the touch input sensor.

10. The electro-optic assembly of claim 9, wherein the input includes at least one of tap inputs and swipe inputs.

11. The electro-optic assembly of claim 1, further including a light source aligned with the touch input sensor.

12. A rearview mirror for a vehicle including the electro-optic assembly of claim 1.

13. An electro-optic assembly comprising:
a first substrate having a first surface and a second surface opposite the first surface;
a second substrate having a third surface and a fourth surface opposite the third surface, the second and third surfaces facing each other to define a gap;
a first electrode coupled to the second surface;
a second electrode coupled to the third surface;
an electro-optic medium located between the first electrode and the second electrode;
a concealment layer located between the electro-optic medium and the first surface; and
a touch input sensor defining a plurality of touch input sections aligned with the concealment layer.

14. The electro-optic assembly of claim 13, including a plurality of indicia, each one of the plurality of indicia aligned with a different one of the touch input sections.

15. The electro-optic assembly of claim 13, wherein the concealment layer defines an opening and the touch input sensor is aligned with the opening.

16. The electro-optic assembly of claim 13, wherein the concealment layer defines an opening and the touch input sensor is located between the opening and the electro-optic medium.

17. The electro-optic assembly of claim 13, wherein the touch input sensor is within the concealment layer.

18. An electro-optic assembly comprising:
a first substrate having a first surface and a second surface opposite the first surface;
a second substrate having a third surface and a fourth surface opposite the third surface, the second and third surfaces facing each other to define a gap;
a first electrode coupled to the second surface;
a second electrode coupled to the third surface;
an electro-optic medium located between the first electrode and the second electrode;
a front substrate having a front surface and a rear surface, the rear surface and the first surface facing each other;
a concealment layer located between the electro-optic medium and the front surface; and
a user interface defining a touch input sensor aligned with the concealment layer.

19. A rearview mirror for a vehicle including the electro-optic assembly of claim 18.

20. The electro-optic assembly of claim 18, wherein the touch input sensor is located between the first surface and the front surface.
